(19) United States
(12) Patent Application Publication
(10) Pub. No.: US 2023/0364578 A1
(43) Pub. Date: Nov. 16, 2023

(54) REACTOR AND METHOD FOR PRODUCING A PRODUCT AND USE

(71) Applicant: TEKNOLOGIAN TUTKIMUSKESKUS VTT OY, Espoo (FI)

(72) Inventors: Pekka SIMELL, Espoo (FI); Ilkka Hannula, Espoo (FI); Tomi LINDROOS, Tampere (FI); Timo KINOS, Tampere (FI); Kimmo KAUNISTO, Tampere (FI)

(21) Appl. No.: 18/247,238

(22) PCT Filed: Sep. 29, 2021
(86) PCT No.: PCT/FI2021/050640

§ 371 Date: Mar. 29, 2023

(30) Foreign Application Priority Data
Oct. 1, 2020 (FI) 20205959

(51) Int. Cl. B01J 19/24; B01J 19/00

(52) U.S. Cl. CPC B01J 19/248; B01J 19/0013; B01J 2219/00076; B01J 2219/2427

(57) ABSTRACT

The invention relates to a reactor and a method for producing a product, wherein the reactor comprises an inner part which is formed at least in part from a porous material comprising a catalyst and in which at least one reactant is arranged to flow into the inner part and after that through the porous material to form a product, a shell structure which surrounds the inner part, a space between the inner part and the shell structure in which the product formed from the reactant in the porous material is arranged to flow out from the reactor, and a heating device for heating electrically the porous material. Further, the invention relates to the use of the reactor.

### FIELD

The application relates to a reactor defined in claim 1 and a method defined in claim 10 for producing a product from at least one reactant. Further, the application relates to a use of the reactor defined in claim 16.

### BACKGROUND

Known from the prior art are different chemical reactors for different reactions, synthesis and treatments.

In chemical processes, e.g. in syngas conversion, the chemical reactors can be heated by exothermic reactions of the gas, like partial oxidation, or indirectly by heating the catalyst bed by external energy. The external energy may be provided by combustion. The catalyst can be placed in the reactor as a catalyst bed, shaped particles, structured foams, monoliths or other catalyst structure. Reactants flow through the catalyst, such as through the catalyst bed.

Some reactions, like RWGS (reverse water gas shift) for syngas production from carbon dioxide and hydrogen or steam or dry reforming, are performed at high temperatures. The reactions are limited by thermodynamic equilibrium and are also hindered by coke formation. Further, heating to required temperature (600-1000° C.) consumes relatively much energy. Further, usually reactor walls are hot and can initiate harmful side reactions.

### OBJECTIVE

The objective is to solve the above problems. Further, the objective is to disclose a new type of reactor for chemical processes. Further, the objective is to disclose a new method and reactor for catalytic reactions. Further, the objective is to disclose the reactor and method, in which the process can be heated electrically.

### SUMMARY

The reactor, method and use are characterized by what are presented in the claims.

The reactor comprises a porous material with a catalyst in an inner part, a shell structure which surrounds the inner part, a space between the inner part and the shell structure and a heating device for heating the reactor for forming a product from reactants. The method for forming a desired product is performed in said reactor.

### BRIEF DESCRIPTION OF THE DRAWINGS

The accompanying drawing, which is included to provide further understanding of the invention and constitutes a part of this specification, illustrates some embodiments of the invention and together with the description help to explain the principles of the invention. In the drawing:

FIG. 1 is a reactor according to one embodiment.

### DETAILED DESCRIPTION

A reactor (1) for producing a product (6) comprises an inner part (2) which is formed at least in part from a porous material comprising a catalyst and in which at least one reactant (5) is arranged to flow into the inner part and after that through the porous material to form a product (6). Further, the reactor comprises a shell structure (3) which surrounds the inner part (2) and a space (4) between the inner part and the shell structure in which the product (6) formed from the reactant or reactants in the porous material, such as in a layer of the porous material, is arranged to flow out from the reactor. Further, the reactor comprises a heating device (8) for heating electrically the porous material.

The method for producing the product (6) comprises: feeding at least one reactant (5) into a reactor (1) which comprises an inner part (2), a shell structure (3) surrounding the inner part and a space (4) between the inner part and shell structure and in which the inner part is formed at least in part from a porous material comprising a catalyst, arranging the reactant (5) to flow into the inner part (2) and after that through the porous material to form a product (6), arranging the product (6) formed from the reactant or reactants in the porous material, e.g. in a layer of the porous material, to flow out from the reactor via the space (4) between the inner part and shell structure, and heating electrically the porous material by means of a heating device (8).

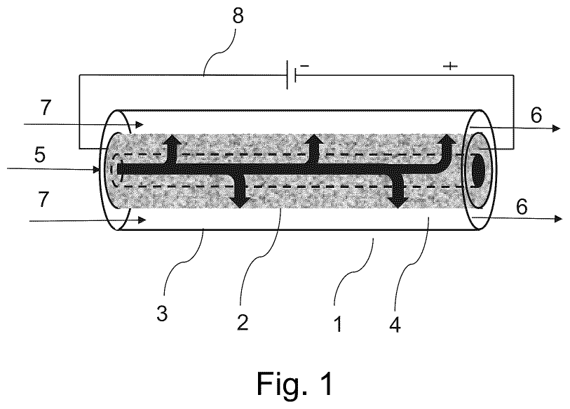

One embodiment of the reactor is shown in FIG. 1.

In one embodiment, the inner part (2) can be a tube, hollow tube, flow channel, plate, sheet or structure with any predetermined shape. In one embodiment, the inner part is an electrically heated structure. In one embodiment, the inner part is the tube, such as the hollow tube, e.g. an electrically heated tube. In one embodiment, the inner part is formed from the porous material, e.g. by shaping, extruding or injection moulding or by other suitable treatment. The inner part may comprise one or more channels.

In one embodiment, the inner part (2) is formed from the porous material. In one embodiment, the inner part comprises at least one porous material layer, e.g. an outer part of the inner part or layer in the inner part. In one embodiment, at least outer wall or walls of the inner part are formed the porous material. In one embodiment, the whole inner part is formed the porous material. In one embodiment, the inner part is formed directly from the porous material without any additional material. In one embodiment, the inner part comprises a support structure which has a predetermined shape for forming the inner part with a desired shape. The support structure may be formed from any suitable material, e.g. metal, ceramic or composite.

The porous material comprises the catalyst. The porous material has a porous structure. In one embodiment, the porous material comprises porous metallic, ceramic and/or composite material. In one embodiment, the porous material is catalytically coated. In one embodiment, the catalyst is arranged on a surface of the porous material. In one embodiment, the catalyst is arranged on surfaces of the pores of the porous material. In one embodiment, the porous material is produced from the start materials comprising the catalyst. In one embodiment, the catalyst is added by coating onto the porous material. The porous material may be formed so that desired pore structure, controlled porosity and/or high specific surface area can be provided to the porous material. In one embodiment, the porous material comprises pores with size of below 500 μm, in one embodiment below 250 μm, in one embodiment below 200 μm, in one embodiment below 150 μm, in one embodiment below 100 μm, and in one embodiment below 50 μm.

In one embodiment, the porous material is procuded by coating an organic space holder material with at least one catalyst or catalytic material of the catalyst to form a coated organic space holder material, by mixing the coated organic space holder material with a carrier material to form a mixture, and by removing the organic space holder material and sintering the mixture to form the porous material with the catalyst, and the porous material comprises pores, and the diameter of the pores is below 500 μm, in one embodiment below 250 μm, in one embodiment below 200 μm, in one embodiment below 150 μm, in one embodiment below 100 μm and in one embodiment below 50 μm. In one embodiment, the carrier material is selected from metal, ceramic material, alloy or their combinations, e.g. FeCrAl-alloy.

The catalyst comprises a catalytic material. The catalyst may be formed from one or more catalytic materials. In one embodiment, the catalyst comprises at least metal, ceramic material, composite material and/or their combination. In one embodiment, the catalyst comprises metal or noble metal, in one embodiment selected from the group consisting of Ni, Co, Fe, Pt, Pd, Rh, other suitable metal, their compounds or their combinations.

In one embodiment, the thickness of the catalyst on the surface of porous material is below 200 μm, in one embodiment 50 nm-200 μm.

The shell structure (3) surrounds the inner part (2). In one embodiment, the shell structure may be an outer tube, vessel or any structure which surrounds the inner part. In one embodiment, the shape of the shell structure is similar than the shape of the inner part. In one embodiment, the shell structure may be formed from any suitable material, e.g. metal, steel, ceramic, composite, other suitable material or their combinations.

The size or volume of the space (4) between the inner part (2) and shell structure (3) can vary depending on the reaction or process. In one embodiment, the space is arranged between an outer surface of the inner part and an inner surface of the shell structure. In one embodiment, the product (6) formed from one or more reactant (5) in the porous material is arranged to flow from inside of the inner part to a surface of the inner part. In one embodiment, the product (6) is rinsed or washed from the surface of the inner part, e.g. by means of a scavenging agent (7), and is arranged to flow out from the reactor (1) via the space (4) between the inner part and the shell structure.

In one embodiment, a scavenging agent (7) is arranged to flow in the space (4) for rinsing or washing the product (6) out from the reactor (1). In one embodiment, the scavenging agent is fed into the space. The reactor comprises a scavenging agent feeder for feeding the scavenging agent to the space between the inner part and shell structure. In one embodiment, the product is rinsed or washed from the surface of the inner part and discharged out from the reactor by means of the scavenging agent. In one embodiment, the scavenging agent is selected from the group consisting of a gaseous material, inert material, steam, carbon dioxide, nitrogen, hydrogen or their combinations. In one embodiment, the scavenging agent is an additional reactant. In one embodiment, the scavenging agent does not react with other reactants or the product.

The reactor is an electrically heated reactor. In one embodiment, the reactor is heated by means of an electric heating device (8). In one embodiment, the porous material, preferably only the porous material or the layer of the porous material, is heated. In one embodiment, the reactor, such as the porous material, is heated resistively or inductively. In one embodiment, the porous material is heated using an electric resistance heating. In one embodiment, the porous material is heated using a joule heating. In one embodiment, the porous material is heated electrically using an induction heating. In one embodiment, the wall of the tube or flow channel with the porous material is heated.

In one embodiment, the heating device (8) comprises at least one electric heating element by which the porous material is heated. In one embodiment, the electric heating element can be resistively heated element, induction heating element or other suitable element or the like. Alternatively, any suitable electric heating element can be used in the heating device (8).

In one embodiment, all reactants (5), i.e. one reactant or more than one reactant, are fed into the inner part. The reactant or reactants may be any reactants which are needed to form a desired product (6). In one embodiment, carbon dioxide and hydrogen are fed as reactants to the reactor, and carbon dioxide and hydrogen react in the porous material to form the product. In one embodiment, at least hydrocarbon is fed as reactant to the reactor, and the hydrocarbon reacts in the porous material to form the product. In one embodiment, hydrocarbons and carbon dioxide or steam are fed as reactants to the reactor, and they react in the porous material to form the product. In one embodiment, naphtha is fed as reactant to the reactor, and the naphtha is cracked in the porous material to form the products.

In one embodiment, the reactor and the method can be used to produce desired products from different reactants in different industrial processes. In one embodiment, the reactor is used for carrying out an electrically heated reactions, chemical reactions, endo and exothermic chemical reactions, syngas conversion, water-gas shift reactions, reverse water-gas shift reactions, steam reforming, hydrocarbon reforming, dry reforming, cracking of hydrocarbon feedstocks, naphtha cracking, methanation, Fischer Tropsch-reactions or their combinations.

Thanks to the invention, chemical reactions can be improved, and more effective processes can be provided. Further, the electrically heated reactor can be provided for chemical reactions. Heat can be provided only the catalyst containing material, and then the heat is provided only to the site where it is needed. As the products are continuously removed from the porous material comprising the catalyst, the reaction can proceed optimally at the maximum rate. The reverse reactions or side reactions do not occur when the products are removed from the active site. Further, thanks to the structure of the reactor, temperature in the outer surface of the shell structure is low, and thus the outer walls of the reactor are not hot during the reaction.

Thanks to the reactor structure, process conditions where carbon formation can be problematic, e.g. lower temperatures and/or high pressures, may be used during the process. Further, inexpensive catalysts, e.g. Ni, Fe, Co, which in conventional processes are prone to carbon formation, may be used in the process.

The reactor and the method offer a possibility to form the products with good properties easily, and energy- and cost-effectively. The present invention provides an industrially applicable, simple and affordable way to form products from different reactants in the different processes. The reactor and the method are easy and simple to realize in connection with industrial production processes. Further, existing processes can be easily modified into processes comprising the present reactor.

### EXAMPLES

The reactor (1) of FIG. 1 comprises an inner part (2), which is a hollow tube and which is formed completely from a porous material comprising a catalyst and in which at least one reactant (5) is arranged to flow into the inner part and after that through the porous material to form a product (6). Further, the reactor comprises a metallic shell structure (3), which is an outer tube, and which surrounds the inner part (2). Further, the reactor comprises a space (4) between the inner part (2) and the shell structure (3), in which the product (6) formed from the reactant or reactants (5) in a porous material layer of the tube is arranged to flow out from the reactor (1). Further, the reactor comprises an electric heating device (8) for heating electrically the porous material. The porous material may be heated using an electric resistance heating. Alternatively, the porous material may be heated electrically using an induction heating.

The porous material is formed metallic and/or ceramic material. The porous material comprises pores, and the diameter of the pores is below 500 μm, e.g. below 200 μm or below 100 μm, depending on the process. The catalyst comprises metal selected from Ni, Co or Fe or precious metal selected from Rh, Pt or Pd depending on the process. The catalyst is arranged on surfaces of the pores of the porous material.

All reactants (5) are fed into the inner part (2). The product (6) is formed from one or more reactant (5) in the porous material, and after that the product is arranged to flow from inside of the inner part to a surface of the inner part. The product (6) is rinsed or washed from the surface of the inner part by means of a scavenging agent (7), e.g. inert gaseous material, and then the product is arranged to flow out from the reactor (1) via the space (4).

### Example 1

In this example, the desired product (6) is formed from reactants (5) in the reactor according to FIG. 1.

Carbon dioxide and hydrogen are fed as the reactants to the inner part (2) of the reactor (1), and carbon dioxide and hydrogen react in the porous material to form the product.

### Example 2

In this example, the desired product (6) is formed from reactants (5) in the reactor according to FIG. 1.

Hydrocarbons and carbon dioxide/steam are fed as the reactants to the inner part (2) of the reactor (1), and the reactants react in the porous material to form the product.

### Example 3

In this example, the desired product (6) is formed from reactants (5) in the reactor according to FIG. 1.

Naphtha is fed as the reactant to the inner part (2) of the reactor (1), and the naphtha is reformed in the porous material to form the products.

The reactor is suitable in different embodiments for using in different industrial processes. The reactor and method are suitable in different embodiments for producing effectively different products from different reactants.

The invention is not limited merely to the examples referred to above; instead many variations are possible within the scope of the inventive idea defined by the claims.

1. A reactor for producing a product in which the reactor comprises an inner part, a shell structure which surrounds the inner part and a space between the inner part and the shell structure, wherein the reactor comprises
an inner part is formed at least in part from a porous material comprising a catalyst, in which at least one reactant is arranged to flow into the inner part and after that through the porous material to form a product,
the porous material is formed from metallic material,
the product formed from the reactant in the porous material is arranged to flow out from the space of the reactor, and
the reactor comprises a heating device for heating electrically the porous material such that the porous material is heated resistively or inductively.

2. The reactor according to claim 1, wherein the inner part is a tube, hollow tube, flow channel, plate, sheet or structure with any predetermined shape.

3. The reactor according to claim 1, wherein the inner part is formed of the porous material.

4. The reactor according to claim 1, wherein the catalyst is arranged on surfaces of the pores of the porous material.

5. The reactor according to claim 1, wherein the product formed from one or more reactant in the porous material is arranged to flow from inside of the inner part to a surface of the inner part.

6. The reactor according to claim 5, wherein the product is rinsed from the surface of the inner part by means of a scavenging agent and is arranged to flow out from the reactor via the space between the inner part and the shell structure.

7. The reactor according to claim 1, wherein the porous material is heated using an electric resistance heating.

8. The reactor according to claim 1, wherein the porous material is heated electrically using an induction heating.

9. A method for producing a product in a reactor which comprises an inner part, a shell structure surrounding the inner part and a space between the inner part and the shell structure, wherein the method comprises
feeding at least one reactant into the reactor in which the inner part is formed at least in part from a porous material comprising a catalyst and in which the porous material is formed from metallic material and arranging the reactant to flow into the inner part and after that through the porous material to form a product,
arranging the product formed from the reactant in the porous material to flow out from the reactor via the space, and
heating electrically the porous material by means of a heating device such that the porous material is heated resistively or inductively.

10. The method according to claim 9, wherein all reactants are fed into the inner part.

11. The method according to claim 9, wherein the porous material is heated using an electric resistance heating.

12. The method according to claim 9, wherein the porous material is heated electrically using an induction heating.

13. The method according to claim 1, wherein carbon dioxide and hydrogen are fed as the reactants to the inner part of the reactor, and the reactants react in the porous material to form the product.

14. The method according to claim 9, wherein at least hydrocarbon is fed as the reactant to the inner part of the reactor, and the reactant reacts in the porous material to form the product.

15. A use of the reactor according to claim 1, wherein the reactor is used for carrying out an electrically heated reactions, chemical reactions, endo and exothermic chemical reactions, syngas conversion, water-gas shift reactions, reverse water-gas shift reactions, steam reforming, hydrocarbon reforming, dry reforming, cracking of hydrocarbon feedstock, naphtha cracking, methanation, Fischer Tropsch-reactions or their combinations.
